(19) United States
(12) Patent Application Publication
(10) Pub. No.: US 2020/0347955 A1
(43) Pub. Date: Nov. 5, 2020

(54) VALVE

(71) Applicant: Vitesco Technologies GmbH, Hannover (DE)

(72) Inventor: Rosario BONANNO, Schwalbach a.Ts. (DE)

(21) Appl. No.: 16/764,956

(22) PCT Filed: Dec. 12, 2018
(86) PCT No.: PCT/EP2018/084446

§ 371 Date: May 18, 2020

(30) Foreign Application Priority Data
Dec. 13, 2017 (DE) 10 2017 222 628.5

(51) Int. Cl. F16K 31/06; F16K 39/02

(52) U.S. Cl. CPC F16K 31/0693; F02B 37/16; F16K 39/022; F16K 31/0655

(57) ABSTRACT

A valve includes a housing, a solenoid arranged in the housing, a pin that can be moved by the solenoid, a piston connected to the pin, and a spring that loads the piston against the force of the solenoid. The valve includes elements for the pressure-supported movement of the piston.

### CROSS REFERENCE TO RELATED APPLICATIONS

This is a U.S. national stage of Application No. PCT/EP2018/084446 filed Dec. 12, 2018. Priority is claimed on German Application No. DE 10 2017 222 628.5 filed Dec. 13, 2017 the content of which is incorporated herein by reference.

### BACKGROUND OF THE INVENTION

### 1. Field of the Invention

The invention relates to a valve comprising a housing, a solenoid arranged in the housing, a pin that can be moved by the solenoid, a piston connected to the pin, and a spring that loads the piston against the force of the solenoid.

### 2. Description of Related Art

A known valve is used, amongst other purposes, as a recirculation dump valve on a turbocharger in a motor vehicle. To prevent excessive deceleration of the turbocharger and to ensure a fast start-up, rapid opening and closing of the valve are essential prerequisites. In particular on closing, immediate sealing is required by contact of the piston on a valve seat. The valve seat separates a region of higher pressure from a region of lower pressure. On closure of the valve, the piston is moved against a higher pressure by a spring. The spring must be designed to be suitably strong. On opening, the coil of the solenoid is moved away from the valve seat by the magnetic force. To guarantee rapid opening, sufficient magnetic force is required, which is achieved by corresponding dimensioning of the coil. The disadvantage here is that because of the coil size, such a valve has a correspondingly large solenoid.

### SUMMARY OF THE INVENTION

One aspect of the invention is a valve with smaller dimensions. Here, the valve should be inexpensive.

According to one aspect of the invention the valve comprises an element for pressure-supported movement of the piston.

The piston moves between the open and closed positions in one direction under the magnetic force of a solenoid, and in the opposite direction under a spring force of a spring. Elements for pressure-supported movement of the piston, which are arranged in the valve according to one aspect of the invention, use the pressure present at the valve such that the pressure force generated by the pressure supports a movement direction of the piston. By using the pressure force, a smaller force need be supplied by the valve in one movement direction. The corresponding components of the valve can thus be dimensioned smaller. The valve according to one aspect of the invention therefore requires less installation space and has a lower weight.

In an advantageous embodiment, the solenoid is configured to open the valve, and the element for pressure-supported movement of the piston support the magnetic force of the solenoid. Such an embodiment allows a significant reduction in coil size. Since the coil is one of the largest components of the valve, the advantages are particularly beneficial in this embodiment.

The pressure for moving the piston may be provided by an external pressure source and supplied to the valve. According to another embodiment, corresponding connecting lines may be omitted if the pressure for moving the piston is the pressure to which the valve is subjected, and preferably the pressure present on one side of the valve seat.

In the simplest case, the pressure present in the region of higher pressure is used to move the piston. Since this pressure is always present for system reasons, no additional pressure-generating measures are required.

In a further advantageous embodiment, the elements for pressure-supported movement comprise a second piston with a valve seat, wherein the second piston is arranged on the pin at a distance from the first piston, preferably at the opposite end of the pin. The arrangement of a second piston with an associated valve seat constitutes an economic embodiment which is simple to produce, since the cost of the valve only increases slightly.

The second piston can be loaded with a higher pressure particularly easily if a pressure path for the higher pressure is formed from the region of higher pressure through the first piston and along the pin up to the second piston. Complex pressure lines may thus be avoided. Such a pressure path can be produced without great additional cost by corresponding compensation bores or a larger diameter in the region of the pin.

If the higher pressure is permanently present at the second piston, rapid opening is possible at all times. Since the pressure is however also present when the valve must close, a corresponding spring is provided with sufficient spring force to guarantee the required rapid closure of the valve and reliably hold the piston in the closed position of the valve.

It has here proved advantageous if the higher pressure supports the movement of the piston only when the piston is actually to be moved. This is achieved with low cost already in that the valve seat of the second piston comprises a first partial valve seat and a second partial valve seat, and that the piston has two sealing faces cooperating with the partial valve seats, wherein the two sealing faces have different diameters, the two sealing faces are axially spaced from each other such that the sealing face with the smaller diameter is arranged closer to the first piston. This arrangement achieves that the higher pressure initially acts only on the region with the sealing face of smaller diameter. The smaller area creates a lower force, whereby the force for holding the valve in the closed position is reduced. The spring applying this holding force may therefore be dimensioned smaller. On opening of the valve, the pin is moved by the magnetic force of the solenoid. At a start of this movement, the sealing face of smaller diameter is moved away from the valve seat so that the higher pressure now acts on the sealing face of larger diameter. Because of the larger area, a greater force is created which supports the solenoid during the remaining opening movement of the valve. In a further advantageous embodiment, this is achieved in that the two partial valve seats are formed by a pot-like cylindrical bore, wherein the first partial valve seat is arranged in the base region of the bore, and the second partial valve seat is arranged in the cylindrical casing surface of the bore. The first partial valve seat in the base region ensures that, on an axial movement of the pin during opening, the sealing face of smaller diameter lifts away immediately, and the pressure acts on the piston face with the sealing face of larger diameter. This sealing face is advantageously arranged on the periphery of the second piston and cooperates with the cylindrical wall of the bore forming the second partial valve seat.

As well as pressure-supported opening however, rapid closure of the valve is also required. In a further embodiment, this is achieved in that the higher pressure is dissipated before closure of the valve. The pressure dissipation takes place particularly easily in that the cylindrical bore has a widening running in the radial direction, such that the second sealing face of the second piston has a distance from the casing surface in the region of the widening. As the pin moves into the opening position, the higher pressure is dissipated through the widening gap. In a particularly simple fashion, the pressure can be dissipated without additional cost if the pressure drop present in the system is used. Because the higher pressure is used exclusively for opening the valve, but not for closing and holding in the closed position, the solenoid and in particular the coil may be dimensioned smaller, without other components such as the spring needing to be made stronger.

The widening can be produced easily and cheaply if configured as a chamfer or radius. The pressure dissipation can be adjusted in targeted fashion via the axial length of the widening. It has proved advantageous if the widening is arranged at a distance from the base region of the pot-like cylindrical bore amounting to at least half, preferably 75 percent, in particular 5 percent of the opening stroke of the valve.

It is however also conceivable that the widening is not formed radially circumferentially, but as a recess arranged in the manner of a groove in the cylindrical wall. Depending on a configuration of the groove, for a constant width, the groove depth may be constant over the length or increase in the direction towards the open position. Similarly, the pressure dissipation may be adjusted by a groove if the width is variable, preferably increasing in the direction of the open position, while the groove depth remains constant.

In order for the pressure support to be achieved in targeted fashion and only support the movement of the piston during opening, a tight seat of the sealing face on the partial valve seat is required. Such a tight connection is achieved a simple fashion if the sealing faces on the second piston each comprise a sealing ring, preferably an O-ring. In particular, in this way tolerances can be reliably compensated.

To use the pressure drop present in the system, against which the higher pressure works, a lower pressure must be supplied to the second piston. A corresponding pressure path is structured particularly simply if this extends from the region of lower pressure along at least a part of the outside of the solenoid up to the side of the second piston facing away from the first piston. Such a pressure path already exists if the outside of the solenoid has a distance from the valve housing. An unnecessary enlargement of the housing, in particular its diameter, can be avoided if the pressure path extends only over part of the diameter in the circumferential direction and over the entire height of the solenoid in the axial direction.

### BRIEF DESCRIPTION OF THE DRAWINGS

The invention will be described in more detail on the basis of an exemplary embodiment. The drawing shows:

FIG. 1 is a sectional depiction of the valve in closed state;

FIG. 2 is the valve from FIG. 1 during opening; and

FIG. 3 is the valve from FIG. 1 in open state.

### DETAILED DESCRIPTION OF THE PRESENTLY PREFERRED EMBODIMENTS

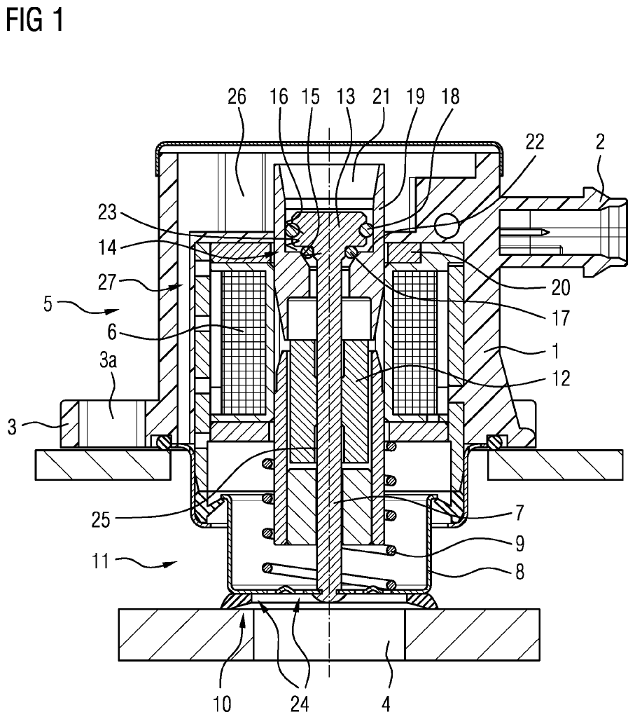

FIG. 1 shows the valve comprising a housing 1 with integrally formed socket 2 for the electrical connection of the valve. The housing 1 furthermore has an integrally molded flange 3 and three bores 3a, by which the housing 1 is flange-mounted on a turbocharger (not illustrated) in the region of the bypass line 4. A solenoid 5 with a coil 6 and a metal pin 7 is arranged in the housing 1, wherein the metal pin 7 is attached to an armature 12, which in turn is mounted inside the coil 6. At its end facing away from the solenoid 5, the metal pin 7 is connected to a pot-like piston 8. In the non-actuated state of the solenoid 5, a spring 9 preloads the piston 8 against a valve seat 10 to close off the bypass line 4, such that no medium can flow from the bypass line 4 into the line 11. Here, the spring 9 is supported on the solenoid 5 and on the piston 8. In closed state of the valve, a pressure of 3 bar is present in the bypass line 4, while the pressure in the line 11 is 1 bar.

The end of the pin 7 facing away from the piston 8 carries a second piston 13, which cooperates with a second valve seat 14. The second valve seat 14 consists of a first partial valve seat 15 and a second partial valve seat 16. The second piston 13 has two sealing faces 17, 18, each of which cooperates with a partial valve seat 15, 16. The sealing faces 17, 18 are each formed by a sealing ring configured as an O-ring. The second valve seat 14 is formed in a housing 19 formed by an upper cover plate 20 of the solenoid 5. The housing 19 has a pot-like bore 21, the base region 22 of which contains the first partial valve seat 15 on which the first sealing face of smaller diameter 17 rests. The second partial valve seat 16 is the cylindrical casing surface 23 of the bore 21. The sealing face 18 of larger diameter, which is also formed by an O-ring, bears on the cylindrical casing surface 23. In the position shown, the bypass line 4 is closed. The interior of the valve is connected to the bypass line 4 via openings 24 in the pin 7 and piston 8, so that a pressure of 3 bar is also present in this region. The pressure from the bypass line 4, which forms a region of higher pressure, is conducted via a first pressure path 25 along the metal pin 7 to the underside of the second piston 13. Because of the smaller area on which the pressure of 3 bar acts, the load on the second piston 13 is low. The spring 9 holds the valve in the closed state. The spring 9 is supported by an additional force acting in the closing direction. This force results from the pressure of 1 bar prevailing in the line 11. A second pressure path 26 is formed via a recess 27 in the housing 1, and leads from the line 11 via the recess 27 to the bore 21 and hence to the top side of the second piston 13. The recess 27 in the housing 1 surrounds the outside of the coil 6 over part of the circumference and over the entire height.

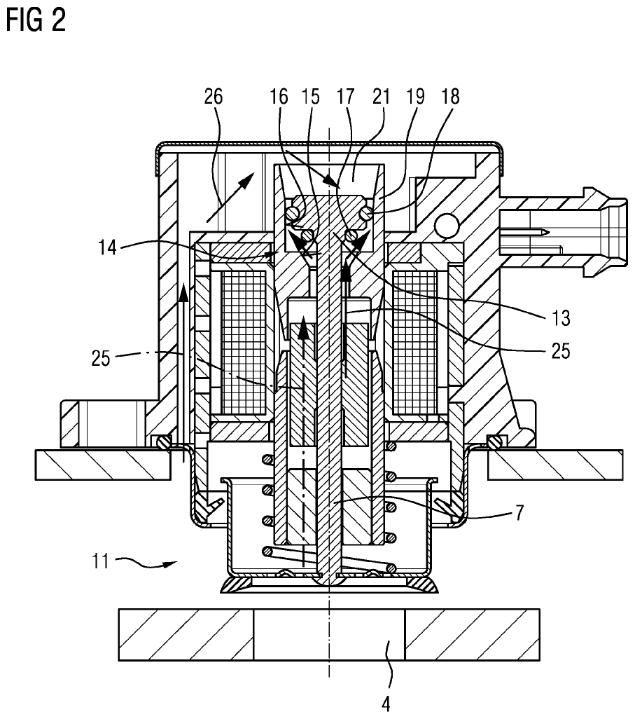

FIG. 2 shows the valve during opening. When the solenoid 5 is energized, the metal pin 7 is attracted slightly. The second sealing face 17 is thereby lifted from the first partial valve seat 15, and the pressure of 3 bar is established in the space between the two O-rings forming the sealing faces 17, 18. Because of the larger area on the underside of the second piston 13, a greater force is created, which supports the opening of the valve. During this movement, the second O-ring 18 slides over the second partial valve seat 16 but still seals against the partial valve seat 16.

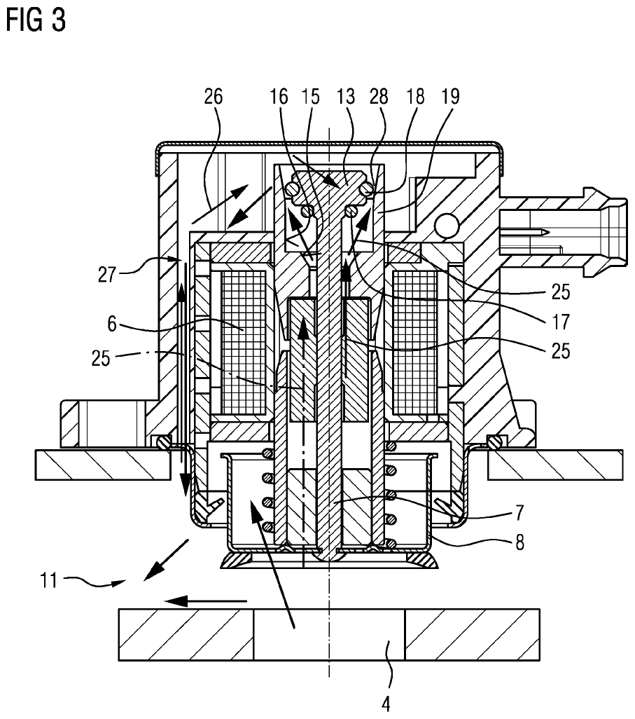

FIG. 3 shows the valve in the open position in which the piston 8 clears the bypass line 4. In this movement, the second piston moves further up. The open end of the cylindrical bore 19 has a chamfer 28 acting as a widening. When, during further movement, the second sealing face of larger diameter 18 enters the region of the chamfer 28, the O-ring forming the second sealing face 18 lifts away from the second partial valve seat 16, creating a connection between the first pressure path 25 and the second pressure path 26. Via this connection, the pressure of 3 bar present in the first pressure path 25 dissipates. As a result of the pressure equalization, the pressure support for opening ends.

To close the valve, the solenoid 5 is de-energized. In the depiction shown, the metal pin 7 with the piston is pressed down by the force of the spring 9 until the piston 8 rests on the valve seat and closes the bypass line 4.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of de-sign choice. It is the intention, therefore, to be limited only as indicated by the scope of the claims appended hereto.

1.-13. (canceled)

14. A valve comprising:
a housing;
a solenoid arranged in the housing;
a pin configured to be moved by the solenoid;
a first piston connected to the pin;
a spring configured to load the first piston against a force of the solenoid; and
an element configured for pressure-supported movement of the first piston.

15. The valve as claimed in claim 14, wherein the solenoid is configured to open the valve and the element configured for pressure-supported movement of the first piston support a magnetic force of the solenoid.

16. The valve as claimed in claim 14, wherein a pressure present on one side of a valve seat is used to move the first piston.

17. The valve as claimed in claim 16, wherein the pressure used to move the first piston is a pressure present in a region of higher pressure.

18. The valve as claimed in claim 15, wherein the element configured for pressure-supported movement of the first piston comprises:
a second piston arranged on the pin at a distance from the first piston; and
a valve seat of the a second piston.

19. The valve as claimed in claim 18, further comprising:
a pressure path for a higher pressure is formed from a region of the higher pressure through the first piston and along the pin up to the second piston.

20. The valve as claimed in claim 19, further comprising:
a pressure path formed in the housing for a lower pressure that extends from a region of lower pressure along at least a part of an outside of the solenoid up to a side of the second piston facing away from the first piston.

21. The valve as claimed in claim 19,
wherein the valve seat of the second piston comprises:
a first partial valve seat; and
a second partial valve seat, and
wherein the second piston comprises a first and a second sealing face cooperating with the first partial valve seat and the second partial valve seat, wherein the first and the second sealing face have different diameters,
the first and the second sealing face are axially spaced from each other such that a sealing face with a smaller diameter is arranged closer to the first piston.

22. The valve as claimed in claim 21,
wherein the first partial valve seat and the second partial valve seat are formed by a pot-like cylindrical bore,
wherein the first partial valve seat is arranged in a base region of the pot-like cylindrical bore, and the second partial valve seat is arranged in a cylindrical casing surface of the pot-like cylindrical bore.

23. The valve as claimed in claim 22, wherein the pot-like cylindrical bore has a widening running in a radial direction such that the second sealing face of the second piston has a distance from a casing surface in a region of the widening.

24. The valve as claimed in claim 23, wherein the widening is formed as one of a chamfer and a radius.

25. The valve as claimed in claim 23, wherein the widening is arranged at a distance from the base region of the pot-like cylindrical bore amounting to at least one of:
half an opening stroke of the valve,
75 percent of the opening stroke of the valve, and
5 percent of the opening stroke of the valve.

26. The valve as claimed in claim 22, wherein the first and the second sealing face on the second piston each comprise a sealing ring.

27. The valve as claimed in claim 19, wherein the second piston is arranged on the pin at an opposite end of the pin from the first piston.

28. The valve as claimed in claim 26, wherein the sealing ring is an O-ring.
